(19) United States
(12) Patent Application Publication
(10) Pub. No.: US 2016/0202818 A1
(43) Pub. Date: Jul. 14, 2016

(54) TOUCH SCREEN DISPLAY AND DRIVING METHOD THEREOF

(71) Applicant: Samsung Display Co., Ltd., Yongin-si (KR)

(72) Inventors: Chae-Han HYUN, Yongin-si (KR); Seung-Kyu LEE, Yongin-si (KR)

(21) Appl. No.: 14/863,163

(22) Filed: Sep. 23, 2015

(30) Foreign Application Priority Data
Jan. 13, 2015 (KR) 10-2015-0006329

(51) Int. Cl. G06F 3/041; G09G 3/20

(52) U.S. Cl. CPC G06F 3/0412; G06F 3/0418; G09G 3/20; G09G 2310/08

(57) ABSTRACT

A touch screen display and method of driving the same are disclosed. In one aspect, the touch screen display includes a display panel including at least one driver and a timing controller. The timing controller is configured to apply at least one clock signal to control the driver. The touch screen display also includes a touch sensing unit including a touch panel and a touch controller. The touch controller is configured to apply a driving signal to the touch panel and the display panel further comprises a noise removing line formed thereon. The timing controller is further configured to invert the at least one clock signal so as to generate at least one inverted clock signal and apply the inverted clock signal to the noise removing line.

### CROSS-REFERENCE TO RELATED APPLICATION

This application claims priority to and the benefit of Korean Patent Application No. 10-2015-0006329, filed on Jan. 13, 2015, in the Korean Intellectual Property Office, the entire contents of which are incorporated herein by reference in their entirety.

### BACKGROUND

1. Field

The described technology generally relates to a touch screen display and a driving method thereof.

2. Description of the Related Technology

Touch screen displays are devices that can display images via a display unit and sense touch input from a user's finger(s) or an object.

Since touch screen displays can eliminate the need for other input devices, such as a keyboard or mouse, they have been widely adopted.

### SUMMARY OF CERTAIN INVENTIVE ASPECTS

One inventive aspect is a touch screen display, including: a display panel including one or more drivers and a timing controller for supplying one or more clock signals for controlling the drivers; and a touch sensing unit including a touch panel and a touch controller for supplying a driving signal to the touch panel, in which a noise removing line is formed in the display panel, and the timing controller supplies one or more inversion clock signals, which are generated by inverting the one or more clock signals, to the noise removing line.

The noise removing line may be formed at least one side of the display panel.

The timing controller may supply i inversion clock signals, which are generated by inverting i clock signals, to the noise removing line in response to i clock signals, wherein i is a natural number.

The driver may include: a scan driver configured to supply a scan signal to scan lines formed on the display panel; and a data driver configured to supply a data signal to data lines formed on the display panel.

The one or more clock signals may be clock signals supplied to the scan driver.

The touch controller may supply the driving signal so as not to overlap a supply period of the scan signal.

Another aspect is a method of driving a touch screen display, which comprises a display panel including a noise removing line at least one side thereof, and a touch panel for detecting a touch, the method including: generating a scan signal, which are to be supplied to scan lines formed on the display panel, by using one or more clock signals; and supplying one or more inversion clock signals, which are generated by inverting the one or more clock signals, to the noise removing line.

Another aspect is a touch screen display, comprising a display panel including at least one driver and a timing controller, wherein the timing controller is configured to apply at least one clock signal to control the driver; and a touch sensing unit including a touch panel and a touch controller, wherein the touch controller is configured to apply a driving signal to the touch panel, wherein the display panel further comprises a noise removing line formed thereon, and wherein the timing controller is further configured to: i) invert the at least one clock signal so as to generate at least one inverted clock signal and ii) apply the inverted clock signal to the noise removing line.

In exemplary embodiments, the noise removing line is formed on at least one side of the display panel. The at least one clock signal can comprise i clock signals, where i is a natural number greater than 1, the at least one inverted clock signal can comprise i inverted clocks signals, and the timing controller can be further configured to apply the i inverted clock signals to the noise removing line at substantially the same time as the i clock signals are applied to the driver.

In exemplary embodiments, the display panel further comprises a plurality of scan lines and a plurality of data lines and wherein the at least one driver includes: a scan driver configured to apply a plurality of scan signals to the scan lines; and a data driver configured to apply a plurality of data signals to the data lines. The timing controller can be further configured to apply the clock signal to the scan driver. The touch controller can be further configured to apply the driving signal so as to not overlap a supply period of the scan signals.

Another aspect is a method of driving a touch screen display, the touch screen display comprising i) a display panel including a noise removing line formed on at least one side thereof and a plurality of scan lines, and ii) a touch panel configured to detect touch input, the method comprising receiving at least one clock signal; generating a plurality of scan signals based at least in part on the clock signal; applying the scan signals to the scan lines; inverting the at least one clock signal so as to generate at least one inverted clock signal; and applying the inverted clock signal to the noise removing line.

In exemplary embodiments, the applying the inverted clock signal further comprises applying the inverted clock signal to the noise removing line so as to not overlap a supply period of the scan signals.

In exemplary embodiments, the at least one clock signal comprises a plurality of clock signals, wherein the at least one inverted clock signal comprises a plurality of inverted clocks signals respectively corresponding to the clock signals, wherein the display panel further includes a scan driver configured to drive the scan lines, wherein the method further comprises applying the clock signals to the scan driver, and wherein the applying the inverted clock signals further comprises applying the inverted clock signals to the noise removing line at substantially the same time as the clock signals are applied to the scan driver.

### BRIEF DESCRIPTION OF THE DRAWINGS

FIG. 1 is a diagram illustrating a touch screen display according to an exemplary embodiment.

FIG. 2 is a diagram illustrating a touch panel according to an exemplary embodiment.

FIG. 3 is a diagram schematically illustrating a display unit according to an exemplary embodiment.

FIGS. 4A and 4B are diagrams illustrating additional examples of the noise removing line illustrated in FIG. 3.

FIG. 5 is a waveform diagram illustrating an exemplary embodiment of inversion clock signals supplied to the noise removing line illustrated in FIG. 3.

FIGS. 6A and 6B are diagrams illustrating the noise of a touch panel generated by clock signals and/or inversion clock signals.

### DETAILED DESCRIPTION OF CERTAIN INVENTIVE EMBODIMENTS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete and will fully convey the scope of the described technology to those skilled in the art.

In the drawings, the dimensions of the illustrated elements may be exaggerated for the sake of clarity. It will be understood that when an element is referred to as being “between” two elements, it can be the only element between the two elements, or one or more intervening elements may also be present. Like reference numerals refer to like elements throughout.

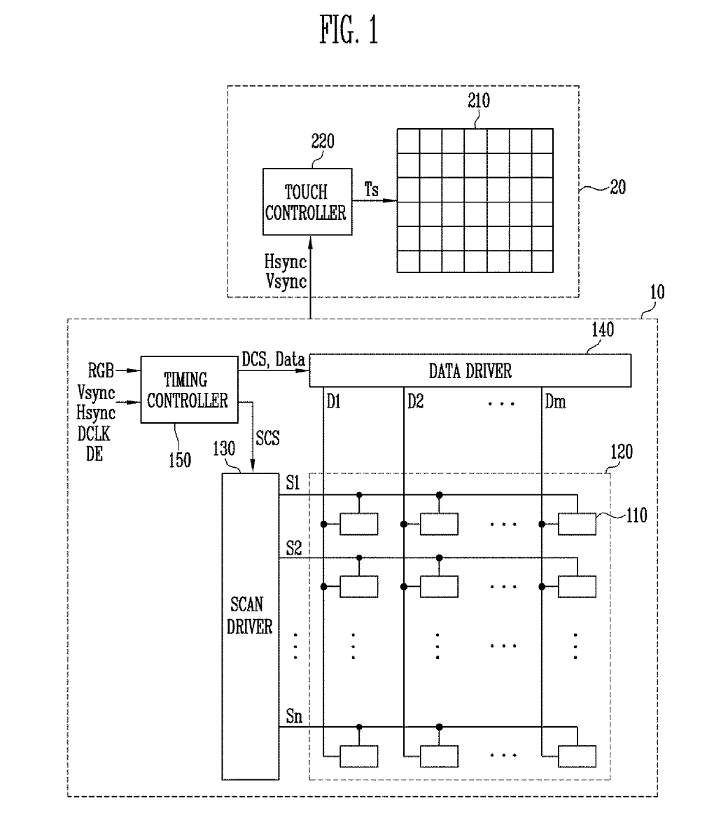

FIG. 1 is a diagram illustrating a touch screen display according to an exemplary embodiment.

Depending on embodiments, certain elements may be removed from or additional elements may be added to the touch screen display illustrated in FIG. 1. Furthermore, two or more elements may be combined into a single element, or a single element may be realized as multiple elements. This applies to the remaining embodiments.

Referring to FIG. 1, the touch screen display includes a display unit 10 and a touch sensing unit 20.

The display unit 10 can display a predetermined image and can be implemented as a panel. The display unit 10 can be implemented as an organic light-emitting diode (OLED) display, a liquid crystal display (LCD), or the like. The display unit 10 includes a pixel unit 120, a scan driver 130, a data driver 140, and a timing controller 150.

The timing controller 150 receives image data RGB and synchronization signals Vsync, Hsync, DCLK, and DE from an external source. Here, the synchronization signals can include a vertical synchronization signal Vsync, a horizontal synchronization signal Hsync, a dot clock DCLK, and a data enable signal DE.

The timing controller 150 receiving the synchronization signals Vsync, Hsync, DCLK, and DE generates a scan driving control signal SCS and a data driving control signal DCS. The scan driving control signal SCS generated by the timing controller 150 is supplied to the scan driver 130 and the data driving control signal DCS generated by the controller 150 is supplied to the data driver 140. Further, the timing controller 150 realigns image data RGB in accordance with at least some of the synchronization signals Vsync, Hsync, DCLK, and DE and supplies the realigned image data RGB to the data driver 140.

The scan driver 130, which receives the scan driving control signal SCS, generates a scan signal and supplies the generated scan signal to scan lines S1 to Sn. For example, the scan driver 130 sequentially supplies the scan signal to the scan lines S1 to Sn. In the meantime, at least one clock signal is included in the scan driving control signal SCS. The number of clock signals included in the scan driving control signal SCS can be variously set in accordance with the configuration the scan driver 130 circuitry. For example, a first clock signal and a second clock signal, which are repeatedly supplied for every period of two times of the horizontal synchronization signal Hsync, can be included in the scan driving control signal SCS.

The data driver 140, which receives the data driving control signal DCS, generates a data signal. The data driver 140 supplies the data signal to data lines D1 to Dm so as to be synchronized with the scan signal.

The pixel unit 120 includes a plurality of pixels 110 that are driven by the scan lines S1 to Sn and the data lines D1 to Dm.

The pixels 110 are selected in horizontal lines in accordance with the scan signal supplied to any one of the scan lines S1 to Sn. Each of the pixels 110 selected by the scan signal receives a corresponding data signal from the data line D1 to Dm connected to the pixel. Each of the pixels 110 receiving the data signal generates light with a predetermined brightness in accordance with the data signal.

The touch sensing unit 20 detects touch input from a user's hand and/or an object. The touch sensing unit 20 includes a touch panel 210 and a touch controller 220.

The touch controller 220 supplies a driving signal Ts to the touch panel 210. To this end, the touch controller 220 receives the horizontal synchronization signal Hsync and/or the vertical synchronization signal Vsync from the display unit 10, and in some embodiments, from the timing controller 150. The touch controller 220, which receives the horizontal synchronization signal Hsync and/or the vertical synchronization signal Vsync from the display unit 10, generates a driving signal Ts so as to not overlap a supply period of the scan signal, and supplies the generated driving signal Ts to the touch panel 210.

The touch panel 210 can be implemented as a resistive, photosensitive, or capacitive type touch panel 210. The touch panel 210 detects touch input from a user's hand and/or an object such as a stylus. In some embodiments, the touch panel 210 is positioned on an upper side of the display unit 10, and thus, a predetermined capacitance may be formed between the touch panel 210 and the display unit 10.

A change in the voltages of the pixels 110 may occur when the scan signal is supplied to any one of the scan lines S1 to Sn due to the capacitance formed between the touch panel 210 and the display unit 10. That is, the data signal supplied to any one of the data lines D1 to Dm is transmitted to the touch panel 20 and may be changed due to the formation of the capacitance between the touch panel 210 and the display unit 10. Accordingly, in at least one embodiment, the touch controller 220 supplies the driving signal Ts to the touch panel 210 so as to not overlap the supply period of the scan signal, and thus, touch input faults of the touch panel 210 that may be generated due to changes in the voltages of the pixels 110 can be prevented.

One or more clock signals are supplied to the scan driver 130 and the voltages of the touch panel 20 may be changed by the capacitance between the touch panel 210 and the display unit 10 when the clock signals are supplied. Accordingly, in at least one embodiment, a noise removing line is added to the display unit 10 to prevent noise due to the clock signals from being transmitted to the touch panel 210 by using the noise removing line. This will be described in detail below.

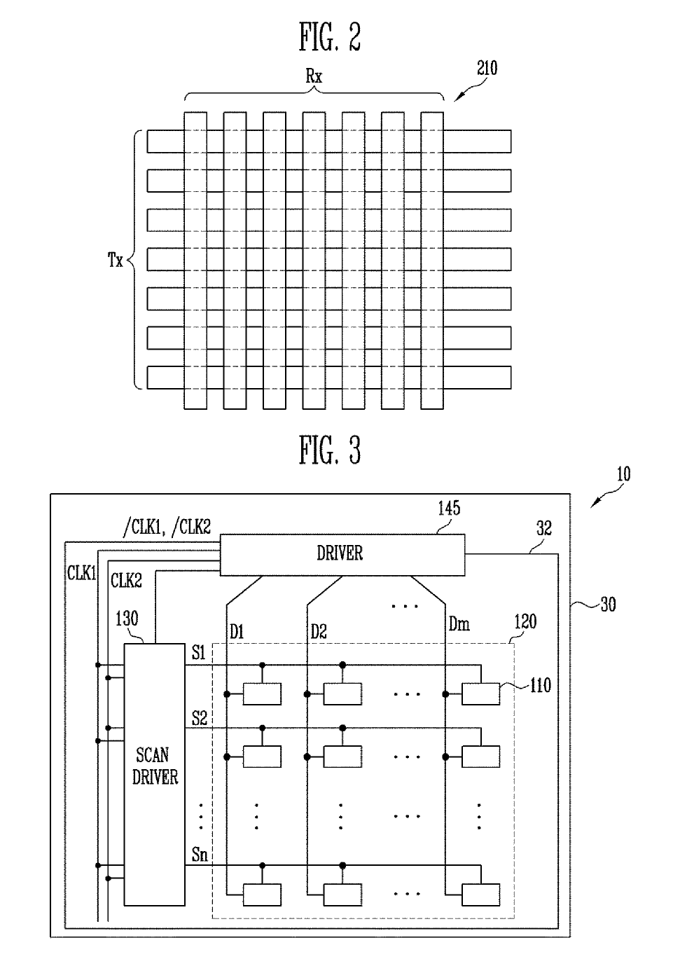

FIG. 2 is a diagram illustrating a touch panel according to an exemplary embodiment. For convenience of description, FIG. 2 illustrates the touch panel 210 implemented as the capacitive type panel.

Referring to FIG. 2, the touch panel 210 includes a plurality of driving electrodes Tx and a plurality of sensing electrodes Rx formed in a direction crossing the driving electrodes Tx.

The driving electrodes Tx and the sensing electrodes Rx can be formed on different layers or the same layer on a transparent substrate (not illustrated) and can be formed of a transparent conductive material. In some embodiments, the transparent conductive material is one or more of the following materials: indium tin oxide (ITO), indium zinc oxide (IZO), carbon nano-tube (CNT), and graphene.

The driving electrodes Tx receive the driving signal Ts from the touch controller 220. For example, the driving electrodes Tx can sequentially receive the driving signal Ts from the touch controller 220.

The sensing electrodes Rx detect variations in capacitance due to touch input and supply the detected variations to a driving circuit (not illustrated).

Here, the driving signal Ts is sequentially supplied to the driving electrodes Tx, so that it is possible to determine a touch area in the touch panel 210 based on the sensing electrode Rx in which the variation in capacitance is detected.

In the meantime, FIG. 2 illustrates that the driving electrodes Tx and the sensing electrodes Rx are arranged in an orthogonally crossing format, but this is one example, and in other embodiments, the driving electrodes Tx and the sensing electrodes Rx can be arranged in another geometrical crossing format, for example, a concentric line and a radial line in a polar coordinates arrangement.

Further, FIG. 2 illustrates that the driving electrodes Tx and the sensing electrodes Rx have bar shapes, but this is one example, and in other embodiments, the driving electrodes Tx and the sensing electrodes Rx can be implemented in diamond shape.

FIG. 3 is a diagram schematically illustrating the display unit according to an exemplary embodiment.

Referring to FIG. 3, the display unit 10 includes a driver 145, the scan driver 130, and the pixels 110 formed on a panel 30 (or a display panel). Further, the scan lines S1 to Sn are formed to connect the pixels 110 to the scan driver 130. The data lines D1 to Dm are formed to connect the pixels 110 to the driver 145.

Here, the driver 145 includes the data driver 140 and the timing controller 150, and can be formed on the panel 30 or embedded in the panel 30 as an integrated circuit (IC). Additionally, with reference to FIG. 3, the data driver 140 and the timing controller 150 have been described as being implemented as one driver 145, but the described technology is not limited thereto. For example, the data driver 140 and the timing controller 150 can be implemented as different ICs and embedded in the panel 30.

The scan driver 130 is formed at one side of the panel 30 to supply scan signals to the scan lines S1 to Sn. The scan driver 130 can be formed on the panel 30 by the same process as that of the pixels 110 or can mounted on the panel 30 as a separate IC. In addition, an additional scan driver can be formed on the panel 30 so that the scan signals can be supplied from both sides of the scan lines S1 to Sn.

The timing controller 150 of the driver 145 supplies a first clock signal CLK1 and a second clock signal CLK2 for driving the scan driver 130. Here, the number of clock signals supplied from the timing controller 150 to the scan driver 130 is set in accordance with the circuit configuration of the scan driver 130. Thereafter, for convenience of description, it is assumed that the first clock signal CLK1 and the second clock signal CLK2 are supplied to the scan driver from the timing controller 150.

A noise removing line 32 is formed on the panel 30 so as to minimize touch input faults of the touch panel 210 due to the first clock signal CLK1 and the second clock signal CLK2. The noise removing line 32 can be formed at various positions of the panel 30. For example, the noise removing line 32 can be formed on at least one side of the panel 30 so as to not overlap the scan lines S1 to Sn and the data lines D1 to Dm.

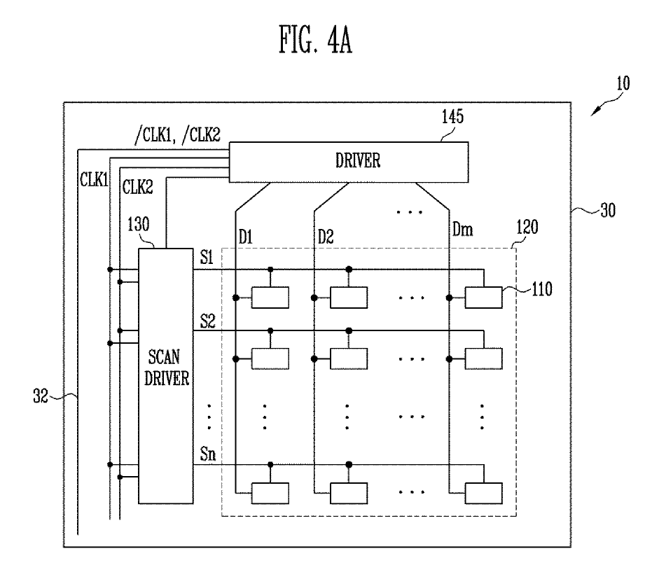

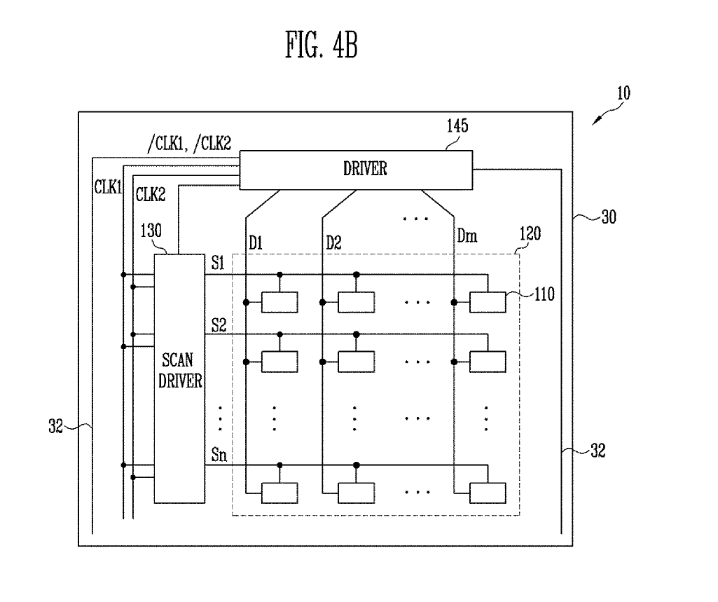

In some embodiments, the position of the noise removing line 32 can be variously set as illustrated in FIGS. 3 to 4B. That is, the noise removing line 32 can be formed at four corners of the panel 30 as illustrated in FIG. 3, at one side of the panel 30 as illustrated in FIG. 4A, or at two corners of the panel 30 as illustrated in FIG. 4B.

The noise removing line 32 can receive inversion clock signals /CLK1 and /CLK2 from the timing controller 150 of the driver 145 as illustrated in FIG. 5. The inversion clock signals /CLK1 and /CLK2 refer to signals generated by inverting the clock signals CLK1 and CLK2. When the inversion clock signals /CLK1 and /CLK2 are supplied to the noise removing line 32, a change in a voltage due to the clock signals CLK1 and CLK2 can be offset, thereby preventing the voltage of the touch panel 210 from being changed.

That is, the inversion clock signals /CLK1 and /CLK2 are supplied together with the clock signals CLK1 and CLK2 at substantially the same time within the panel 30, and thus, noise generated due to the clock signals CLK1 and CLK2 and noise generated due to the inversion clock signals /CLK1 and /CLK2 are offset, so that the generation of touch input faults in the touch panel 210 can be prevented.

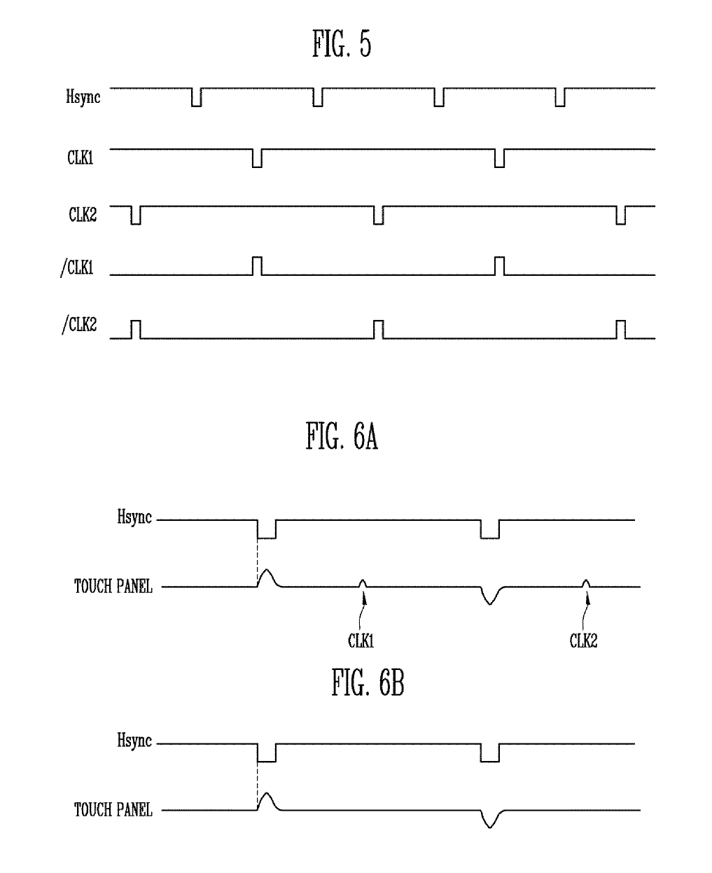

When the inversion clock signals /CLK1 and /CLK2 are not supplied to the panel 30, a voltage in the form of a noise is generated in the touch panel 20 whenever the first clock signal CLK1 and the second clock signal CLK2 are supplied as illustrated in FIG. 6A.

However, when the inverted clock signals /CLK1 and /CLK2 are supplied to the noise removing line 32 in accordance with at least one embodiment, the voltage of the touch panel 20 can be prevented from being changed by offsetting the noises of the clock signals CLK1 and CLK2 and the inverted clock signals /CLK1 and /CLK2 as illustrated in FIG. 6B.

That is, according to at least one embodiment, the noise removing line 32 is formed on at least one side of the panel 30, and i (where i is a natural number) inverted clock signals are supplied to the noise removing line 32 in response to i clock signals, so that it is possible to minimize touch input faults.

By way of summation and review, a touch screen display includes a display unit and a touch sensing unit. The display unit implements a predetermined image. The touch sensing unit detects touch input from a user's hand or an object. Here, the touch sensing unit can be implemented are a resistive, photosensitive, or capacitive type panel.

The display unit uses a scan signal and a data signal for implementing an image. Here, a predetermined noise corresponding to a voltage change is generated at a supply period of the scan signal and the data signal of the display unit and the generated noise is transmitted to a touch sensing unit due to the capacitance between the display unit and the touch sensing unit. Accordingly, the touch sensing unit controls a driving signal so that touch driving is not performed at a section in which voltages of the scan signal and the data signal are changed. That is, the touch sensing unit controls the driving signal so that the driving for driving a touch is supplied so as to not overlap the supply period of the scan signal. To this end, the touch driver recognizes the supply period of the scan signal by using a horizontal synchronization signal and/or a vertical synchronization signal.

Additionally, the display unit includes a data driver for supplying a data signal and a scan driver for supplying a scan signal. The scan driver receives a plurality of clock signals for supplying a scan signal. Here, a voltage change by the clock signal is transmitted to the touch sensing unit and thus a touch may not be properly detected. Particularly, the clock signal supplied to the scan driver may overlap the driving signal for driving a touch in a partial period, thus increasing a probability that a touch input fault is generated.

According to the touch screen display and the driving method thereof according to at least one exemplary embodiment, the noise removing line is formed on the display unit and inversion clock signals, which are signals generated by inverting the clock signals, are applied to the noise removing line. Then, noise generated due to the clock signals and noise generated due to the inversion clock signals are offset, thereby preventing touch input faults from being generated.

Example embodiments have been disclosed herein, and although specific terms are employed, they are used and are to be interpreted in a generic and descriptive sense only and not for the purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the invention as set forth in the following claims.

What is claimed is:

1. A touch screen display, comprising:
a display panel including at least one driver and a timing controller, wherein the timing controller is configured to apply at least one clock signal to control the driver; and
a touch sensing unit including a touch panel and a touch controller, wherein the touch controller is configured to apply a driving signal to the touch panel,
wherein the display panel further comprises a noise removing line formed thereon, and
wherein the timing controller is further configured to: i) invert the at least one clock signal so as to generate at least one inverted clock signal and ii) apply the inverted clock signal to the noise removing line.

2. The display device of claim 1, wherein the noise removing line is formed on at least one side of the display panel.

3. The display device of claim 1, wherein the at least one clock signal comprises i clock signals, where i is a natural number greater than 1, wherein the at least one inverted clock signal comprises i inverted clocks signals, and wherein the timing controller is further configured to apply the i inverted clock signals to the noise removing line at substantially the same time as the i clock signals are applied to the driver.

4. The display device of claim 1, wherein the display panel further comprises a plurality of scan lines and a plurality of data lines and wherein the at least one driver includes:
a scan driver configured to apply a plurality of scan signals to the scan lines; and
a data driver configured to apply a plurality of data signals to the data lines.

5. The display device of claim 4, wherein the timing controller is further configured to apply the clock signal to the scan driver.

6. The display device of claim 4, wherein the touch controller is further configured to apply the driving signal so as to not overlap a supply period of the scan signals.

7. A method of driving a touch screen display, the touch screen display comprising i) a display panel including a noise removing line formed on at least one side thereof and a plurality of scan lines, and ii) a touch panel configured to detect touch input, the method comprising:
receiving at least one clock signal;
generating a plurality of scan signals based at least in part on the clock signal;
applying the scan signals to the scan lines;
inverting the at least one clock signal so as to generate at least one inverted clock signal; and
applying the inverted clock signal to the noise removing line.

8. The method of claim 7, wherein the applying the inverted clock signal further comprises applying the inverted clock signal to the noise removing line so as to not overlap a supply period of the scan signals.

9. The method of claim 7, wherein the at least one clock signal comprises a plurality of clock signals, wherein the at least one inverted clock signal comprises a plurality of inverted clocks signals respectively corresponding to the clock signals, wherein the display panel further includes a scan driver configured to drive the scan lines, wherein the method further comprises applying the clock signals to the scan driver, and wherein the applying the inverted clock signals further comprises applying the inverted clock signals to the noise removing line at substantially the same time as the clock signals are applied to the scan driver.
